(19) United States
(12) Patent Application Publication
(10) Pub. No.: US 2024/0369675 A1
(43) Pub. Date: Nov. 7, 2024

(54) RADAR SYSTEM, AND ASSOCIATED BODYWORK PART AND VEHICLE

(71) Applicant: COMPAGNIE PLASTIC OMNIUM SE, LYON (FR)

(72) Inventors: Mathieu BANCELIN, Sainte-Julie (FR); Philippe GILOTTE, Sainte-Julie (FR); Laurent ROCHEBLAVE, Sainte-Julie (FR); Frédéric STABLO, Sainte-Julie (FR)

(73) Assignee: COMPAGNIE PLASTIC OMNIUM SE, LYON (FR)

(21) Appl. No.: 18/686,698

(22) PCT Filed: Sep. 2, 2022
(86) PCT No.: PCT/EP2022/074503

§ 371 Date: Feb. 26, 2024

(30) Foreign Application Priority Data
Sep. 3, 2021 (FR) FR2109245

(51) Int. Cl. G01S 7/02; G01S 7/03; G01S 13/931

(52) U.S. Cl. CPC G01S 7/028; G01S 7/03; G01S 13/931; G01S 2013/93271; G01S 2013/93275

(57) ABSTRACT

Radar system (200) for a motor vehicle includes an electronic unit (900) configured to transmit and receive an electromagnetic wave in a predetermined frequency range, a first directional antenna (300a) comprising a first reflective cavity (400a) reflecting electromagnetic waves, in which a first metasurface (500a) is positioned, a second directional antenna (300b) comprising a second reflective cavity (400b) reflecting electromagnetic waves, in which a second metasurface (500b) is positioned.

The present disclosure relates to the field of motor vehicles, for example automobiles, equipped with a radar system for emitting and/or receiving an electromagnetic wave in a desired direction, in particular for detecting an obstacle.

Motor vehicles are known that are equipped with radar-type devices, generally positioned on the front and rear bumpers of the vehicle. These radar devices are used for parking assistance as well as for driving assistance, for example for adaptive cruise control (ACC) applications wherein the radar device detects the speed and the distance of a vehicle preceding the vehicle carrying the radar device. Such a radar is used in particular to regulate vehicle speed based on the traffic and/or obstacles on the road. The radar detects the speed and the distance of the object preceding the carrier vehicle, so as in particular to maintain a safety distance between the vehicles.

In general, a major area of application for radars in the motor vehicle industry is that of the vehicle bodywork wherein more and more radar modules are being integrated in order to allow total peripheral detection around the vehicle, for example for equipment such as parking assistance systems, reversing assistance systems or pedestrian protection installations, or other systems of this type. However, these various radars are of different types depending on their detection field (long or short distance, front detection or lateral detection, etc.) and their function (parking, autonomous driving, etc.), but also according to their manufacturer, which does not allow them to optimally consolidate the data provided by each one independently to the various equipment of the vehicle that can use them (braking, steering, headlights, sound or visual alarms, etc.).

Thus, in order to better characterize the peripheral environment of the vehicle, motor vehicle manufacturers need devices making it possible to improve, on the one hand, the size of the volume to be monitored around the vehicle, and on the other hand, the resolution of the processing of the information originating from these devices. This is intended to allow the vehicle to interact optimally, that is, with more precision and more quickly, with its environment, in particular to avoid accidents, facilitate maneuvers and drive autonomously.

In order to increase the peripheral detection by volume (3D) around the vehicle, automobile manufacturers are led to multiply the number of radars distributed over a given surface.

However, the increase in the number of radars used leads to an increase in the cost.

In addition, the increase in the number of radars requires a continuous supply of numerous radiofrequency tracks, which consumes considerable energy, which is very detrimental in particular for autonomous and/or electric vehicles.

Moreover, even if the radars can be miniaturized slightly, the increase in the number of radars distributed over a given surface may be difficult to achieve due to the limited available area (the size of the bodywork parts cannot be increased) as well as the presence of other equipment, all the more so since it may be necessary to maintain a minimum distance between each radar in order to prevent them from interfering with one another.

In order to obtain additional information relative to the position and speed of an obstacle given by the radars, devices are sought which in particular have an increased spatial resolution making it possible for example to recognize the objects (environment or obstacles) surrounding the vehicle, to track their trajectory, to constitute the most comprehensive imaging thereof as possible.

Thus, vehicles are increasingly provided with complementary devices to radars, such as LIDAR and cameras.

The spatial resolution expresses the ability of an observation device to distinguish details. It can be characterized in particular by the minimum distance that must separate two contiguous points so that they are correctly discerned.

In the case of a radar, this resolution distance is based on the ratio between the wavelength of the wave used for the observation, and the size of the opening of the observation device. Thus, to improve the spatial resolution, that is, to decrease the resolution distance, it is necessary to reduce the wavelength (to increase the frequency of the wave) and/or necessary to increase the opening of the observation device. Indeed, the spatial resolution R is characterized by the following equation:

$$R = \frac{c * L}{f * O}$$

with c the speed of the light, L the distance between the observation device and the target, f the frequency of the radar and O the opening the observation device.

This is why today it is sought to use radars operating at higher frequency, for example at 77 GhZ instead of 24 GHz.

On the contrary, the miniaturization of current radars leads to reducing their opening and therefore their resolution.

Furthermore, a problem encountered for a radar carried by a bodywork part relates to the positioning of the radar. Indeed, it is important to be able to ensure the integrity of a radar, so that it performs its function correctly, even in the event of deformation of the bodywork part bearing it (impact, thermal expansion, etc.). It is therefore necessary to ensure proper positioning of the radar (maintained direction of emission/reception) throughout the duration of use of the radar function.

It is therefore appropriate to provide a solution making it possible to provide the position and the speed of the objects located around the vehicle and to obtain a more suitable range and spatial resolution, while limiting the cost and energy consumption of the detection device. This makes it possible to improve the detection of objects or persons around the vehicle and to facilitate the implantation of such systems in autonomous vehicles, in particular electric vehicles whose consumption must be limited as much as possible.

To this end, the present disclosure relates to a radar system for a motor vehicle comprising:
an electronic unit configured to transmit and receive an electromagnetic wave in a predetermined frequency range,
a first directional antenna comprising a first reflective cavity reflecting electromagnetic waves wherein a first metasurface is positioned, said first antenna being configured to be connected to the electronic unit via a first waveguide and to transmit an electromagnetic wave, emitted by the electronic unit and propagated via the first waveguide, in a first predetermined direction and/or to propagate an electromagnetic wave received from the first predetermined direction to the electronic unit via the first waveguide,
a second directional antenna comprising a second reflective cavity reflecting electromagnetic waves wherein a second metasurface is positioned, said second antenna being configured to be connected to the electronic unit via a second waveguide and to transmit an electromagnetic wave, emitted by the transmitter/receiver and propagated via the second waveguide, in a second predetermined direction and/or to propagate an electromagnetic wave received from the second predetermined direction to the electronic unit via the second waveguide.

According to another aspect of the present disclosure, the first antenna, called transmitting antenna, is configured to emit an electromagnetic wave originating from the electronic unit and propagated via the first waveguide in the first predetermined direction and the second antenna, called receiving antenna, is configured to receive the electromagnetic wave emitted by the transmitting antenna and reflected by an obstacle in the second predetermined direction and to propagate the received electromagnetic wave to the electronic unit via the second waveguide.

According to another aspect of the present disclosure, the first predetermined direction corresponds to an emission cone around a central emitting axis and the second predetermined direction corresponds to a receiving cone around a central receiving axis.

According to an additional aspect of the present disclosure, the azimuth deviation between the central emitting axis and the central receiving axis is less than 30°.

According to an additional aspect of the present disclosure, the difference in elevation between the central emitting axis and a horizontal direction on the one hand and between the central receiving axis and a horizontal direction on the other hand is less than 5°, in particular equal to 0°.

According to another aspect of the present disclosure, the sections of the emission cone and of the receiving cone have an elongated
shape, in particular oblong, and the antennas are arranged so that, on the one hand, the pitch angle of the antenna formed by the angular gap between the large axis of the elongated shape and a horizontal direction is less than 30°, in particular less than 5°, and on the other hand the angular deviation between the pitch angle of the first antenna and the second antenna is less than 30°, in particular less than 5°.

According to an additional aspect of the present disclosure, the predetermined frequency range is greater than 60 GHz, in particular between 75 and 80 GHz, in particular 77 GHz. The predetermined frequency range may also be between 120 and 160 GHz, in particular 140 GHz.

According to an additional aspect of the present disclosure, the first and second antennas are configured to be arranged on a bodywork part comprising a wall made of plastic material.

According to another aspect of the present disclosure, the electronic unit is configured to be positioned at a distance from the bodywork part.

According to an additional aspect of the present disclosure, the radar system comprises:
a transmitting antenna configured to emit an electromagnetic wave emitted by the electronic unit in a predetermined direction,
a first and a second receiving antenna configured to receive the electromagnetic wave emitted by the transmitting antenna and reflected by an obstacle and to propagate the received reflected electromagnetic wave toward the electronic unit,
the transmitting antenna and the receiving antennas being arranged on a bodywork part comprising a wall made of plastic material, in particular on a bumper.

According to another aspect of the present disclosure, the bodywork part extends along the width of the vehicle and wherein the antennas are arranged in different areas of the bodywork part, the different areas being offset from one another along the width of the vehicle and wherein the transmitting antenna is arranged in a central area relative to the areas associated with the receiving antennas.

According to an additional aspect of the present disclosure, the first receiving antenna defines a first receiving cone around a central receiving axis forming an azimuth angle of less than 5°, in particular 0°, relative to a direction of forward movement of the vehicle, the second receiving antenna defines a second receiving cone around a central receiving axis forming an azimuth angle greater than 20°, in particular 40°, relative to a direction of forward movement of the vehicle and the transmitting antenna defines an emission cone around a central emitting axis forming an azimuth angle between 0° and 10° with respect to a direction of forward movement of the vehicle.

The present disclosure also relates to a bodywork part comprising a radar system as described above.

According to an additional aspect of the present disclosure, the bodywork part comprises at least one wall made of plastic, an emitting antenna connected to the electronic unit via a first waveguide and configured to emit an electromagnetic wave emitted by the electronic unit in a predetermined direction, a receiving antenna connected to the electronic unit via a second waveguide, said receiving antenna being configured to receive the electromagnetic wave emitted by the transmitting antenna and reflected by an obstacle and to propagate the received reflected electromagnetic wave toward the electronic unit, said transmitting and receiving antennas being arranged behind the wall made of plastic material.

According to another aspect of the present disclosure, the transmitting antenna and the receiving antenna are arranged in a uniform area of the bodywork part. The uniform area corresponds to an area having a constant thickness and made of the same material or the same layers of materials, the various layers having the same thicknesses.

According to an additional aspect of the present disclosure, the bodywork part is a front bumper of a vehicle, in particular a land motor vehicle, and comprises a first receiving antenna arranged in a central area of the bumper and whose central axis of the receiving cone is oriented in a direction of forward movement of the vehicle, a second receiving antenna arranged in a lateral area of the bumper and whose central axis of the receiving cone is oriented at an azimuth angle greater than 30° relative to the direction of forward movement of the vehicle, and a transmitting antenna is arranged in an intermediate area located between the central area and the lateral area, the central axis of the emission cone forming an azimuth angle between 0 and 30° relative to the direction of forward movement of the vehicle.

According to an additional aspect of the present disclosure, the antennas have an elongated shape and the length of the different antennas can be different from one antenna to another. At least one of the antennas has a length different from the length of the other antennas.

The present disclosure also relates to a land motor vehicle comprising a bodywork part as described above.

### BRIEF DESCRIPTION OF THE FIGURES

The various disclosed embodiments will be better understood upon reading the following description, which is provided merely as example and with reference to the appended drawings, wherein:

FIG. 1 is a diagram of a radar system according to an embodiment;

FIG. 2 is a perspective view of two antennas of the radar system of FIG. 1;

FIG. 3 is a top view of two antennas arranged on the rear face of a bodywork part according to an embodiment;

FIG. 4 is a side view of an antenna arranged on a bodywork part according to an embodiment;

FIG. 5 is a view of a projection onto a plane YZ of two antennas arranged on a bodywork part according to an embodiment;

FIG. 6 is a top view of a bodywork part comprising a radar system with three antennas according to an embodiment;

FIG. 7 is a perspective view of a motor vehicle comprising a radar system according to an embodiment; and

FIG. 8 is a top view of a motor vehicle comprising a radar system according to an embodiment.

### DETAILED DESCRIPTION

In these figures, identical elements bear the same references.

The following embodiments are examples. Although the description refers to one or more embodiments, this does not necessarily mean that each reference relates to the same embodiment, or that the features apply only to a single embodiment. Simple features of different embodiments can also be combined or interchanged to provide other embodiments.

In the present description, it is possible to index certain elements or parameters, such as for example first element or second element as well as first parameter and second parameter or first criterion and second criterion, etc. In this case, it is a simple indexing for differentiating and naming similar but non-identical elements or parameters or criteria. This indexing does not mean that one element, parameter or criterion has priority relative to another, and such designations can easily be changed without departing from the scope of the present description. This indexing does not imply a temporal order, for example, for assessing such a criterion.

Furthermore, in the context of the present disclosure, the orientations are to be understood relative to an XYZ trihedron linked to the vehicle wherein the axis X corresponds to the normal direction of advance of the vehicle, the axis Y corresponds to a transverse axis of the vehicle and the axis Z corresponds to the direction opposite gravity when the vehicle is resting on a flat surface. The plane XY then forms a horizontal plane and the axis Z corresponds to a vertical direction. For any direction D, its azimuth is the angle formed by its projection in the plane XY with the axis X, its elevation is the angle formed by its projection in the plane XZ with the axis X. The axis X corresponds to the value 0° for the azimuth angle (in the plane XY) and the elevation angle (in the plane XZ).

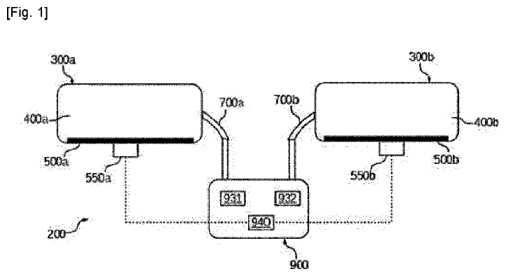

The present disclosure relates to a radar system for a motor vehicle, in particular for an automobile, but the present disclosure can also apply to other types of motor vehicles, in particular land or flying vehicles. FIG. 1 depicts a diagram of a radar system 200 according to one embodiment of the present disclosure. The radar system 200 comprises an electronic unit 900 comprising a primary transmitter 931 configured to emit an electromagnetic wave in a predetermined frequency range and a primary receiver 932 configured to receive an electromagnetic wave in the predetermined frequency range. The predetermined frequency range corresponds to values greater than 60 GHz, in particular between 75 and 80 GHz, for example 77 GHz, which is the standardized value of automotive radar devices. Frequencies between 120 and 160 GHz, in particular 140 GHz, are also possible. The electronic unit 900 also comprises control electronics 940 configured to control the transmitter 931 and the receiver 932.

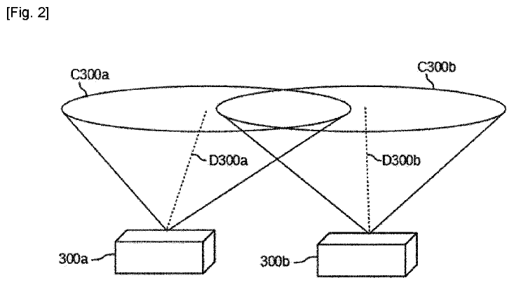

The radar system 200 also comprises a first directional antenna 300a comprising a first reflective cavity 400a reflecting electromagnetic waves, wherein a first metasurface 500a is positioned. The reflective cavity 400a corresponds to a volume configured to reflect electromagnetic waves at the limits of the volume. The reflective surfaces are for example embodied by metal surfaces. The reflective cavity 400a also comprises non-reflective portions arranged opposite the bodywork part to allow the emission and/or reception of an electromagnetic wave in a predetermined direction. The predetermined direction corresponds to an emission and/or reception cone C300a around a first central axis D300a as shown in FIG. 2. The first central axis D300a extends for example in a direction perpendicular to the plane formed by the metasurface and/or by an output face of the first directional antenna 300a (the first directional antenna 300a has a parallelepiped shape and the output face corresponds to one of the faces of the parallelepiped). The shape of the emission and/or reception cone C300a depends in particular on the shape of the metasurface 500a. With a metasurface 500a of elongated shape, for example rectangular, the emission and/or reception cone C300a for example also has an elongated section, for example oval or oblong, the large axis of which corresponds to the longitudinal axis of the metasurface 500a. A control electronics item 550a is for example associated with the metasurface 500a and connected to the control electronics 940 of the electronic unit 900.

The first antenna 300a is connected to the electronic unit 900 via a first waveguide 700a. The first waveguide 700a makes it possible to propagate an electromagnetic wave emitted by the emitter 931 of the electronic unit 900 toward the first antenna 300a and/or to propagate an electromagnetic wave received by the first antenna 300a to the receiver 932 of the electronic unit 900.

The radar system 200 also comprises a second directional antenna 300b with a second predetermined direction corresponding to a second emission and/or reception cone C300b around a second central axis D300b (see FIG. 2). The second antenna 300b comprising a second cavity 400b reflecting the electromagnetic waves wherein a second metasurface 500b is positioned. A control electronics item 550b is for example associated with the metasurface 500b and connected to the control electronics 940 of the electronic unit 900. The constituent elements of the second antenna 300b may be similar to the constituent elements of the first antenna 300a. The two antennas 300a and 300b can be identical, which makes it possible to standardize the production and thus reduce costs.

However, the second antenna 300b may have different dimensions from the first antenna 300a. In addition, the orientations, in particular in the azimuthal direction, of the first 300a and the second 300b antennas can be different, such that the first and the second predetermined directions can be different.

The second antenna 300b is connected to the electronic unit 900 via a second waveguide 700b. The second waveguide 700b makes it possible to propagate an electromagnetic wave emitted by the emitter 931 of the electronic unit 900 toward the second antenna 300b and/or to propagate an electromagnetic wave received by the second antenna 300b to the receiver 932 of the electronic unit 900.

As shown in FIG. 2, the antennas 300a and 300b can have an elongated shape corresponding to the shape of the metasurface 500a, 500b and the emission and/or receiving cone C300a, C300b associated with the antenna for example has an oblong section whose major axis corresponds to the longitudinal axis of the antenna 300a, 300b and is proportional to the large dimension of the metasurface 500a, 500b. The emission and/or reception angle is for example between 80 and 110°, in particular about 90° (+/−45° relative to the central axis D300a, D300b) along the large axis of the oblong shape and of about 20° (+/−10° relative to the central axis D300a, D300b) along the small axis of the oblong shape.

In the case where the first antenna 300a is the transmitting antenna and the second antenna 300b is the receiving antenna, the angular deviation between the first central axis D300a and the second central axis D300b (measured in the plane defined by the directions D300a and D300b) is preferably approximately equal to 30° so as to limit the losses and maximize the scope of the radar detection.

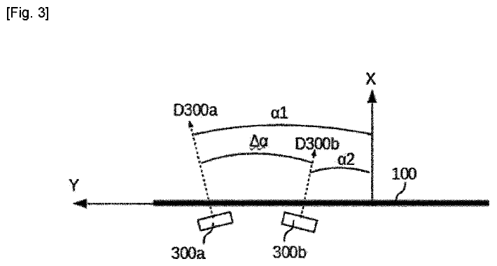

In the case of implantation in a motor vehicle 1 such as an automobile and in particular on a front bodywork part 100 such as a front bumper or a grille as shown in projection in the top view of FIG. 3, the angular deviation Δα between the azimuth angle α1 of the first central axis D300a and the azimuth angle α2 of the second central axis D300b is preferably less than or equal to 30°, for example equal to 30° so as to optimize the detection.

For a lateral detection for which the required range is less significant, a difference in azimuth angle Δα between the first central axis D300a and the second central axis D300b greater than 30°, in particular 40°, can be used.

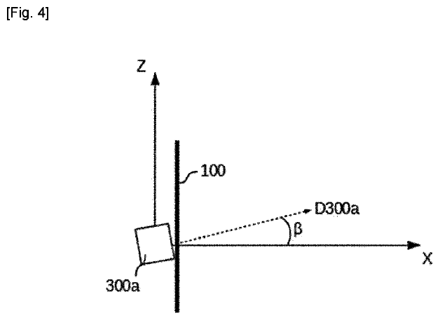

In order to limit the non-relevant detections, for example the detection of a bridge or a walkway in the case of an automobile, as shown in projection in FIG. 4, the elevation angle β of the first or second central axis D300a, D300b is less than 10° (+/−5° relative to the horizontal direction), preferably less than 5° (+/−2.5° relative to the horizontal direction).

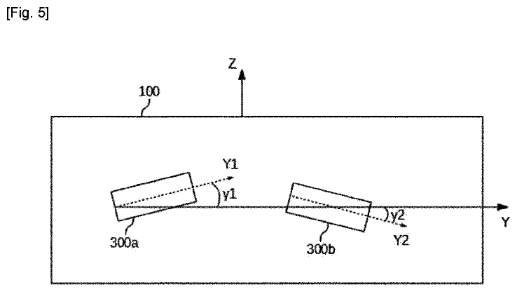

Furthermore, still to limit the non-relevant detections, as shown in the front projection view of FIG. 5, the pitch angle γ1 or γ2 between the longitudinal direction of the antenna Y1 or Y2 (corresponding to the large axis of the section of the emission or receiving cone associated with the antenna) with the horizontal direction is less than 30°, in particular less than 5°. The pitch angles of the antennas 300a, 300b will be chosen substantially equal to maximize the detection range. The difference between the pitch angles of the two antennas 300a and 300b will for example be less than 30°, in particular less than 5°.

The antennas 300a, 300b are preferably placed behind a uniform area of the bodywork part 100, that is, having a uniform composition and a constant thickness, so as to limit the parasitic reflections of the electromagnetic wave. For this reason, if possible, placing the antenna between two bodywork parts 100 will be avoided.

The first antenna 300a can be a transmitting antenna used only for emitting an electromagnetic wave and the second antenna 300b may be a receiving antenna used only for receiving an electromagnetic wave. In this case, the emission and the reception can be continuous, which makes it possible to obtain continuous detection. The receiving antenna 300b is then configured to detect the electromagnetic wave emitted by the transmitting antenna 300a and reflected by an obstacle located in the emission cone C300a of the transmitting antenna 300a toward the receiving cone C300b of the receiving antenna 300b.

In this case, the difference in pitch angle between the longitudinal direction Y1 of the first antenna 300a and the longitudinal direction Y2 of the second antenna 300b is preferably less than 30°, in particular less than 10°, for example 0°, so as to limit the losses between the emission and the reception and thus to maximize the detection range.

The antennas 300a, 300b and in particular the metsurfaces 500a, 500b are also placed as close as possible to the inner surface of the bodywork part 100 in order to limit potential interfering reflections.

Using a first 300a and a second 300b antenna of the same radar system 200 having different orientations also makes it possible to increase the detection field relative to the use of a single antenna.

Furthermore, the configuration of the radar system 200 makes it possible to position the antennas 300a, 300b as close as possible to the inner surface of the bodywork part 100 so as to limit the losses or the risk of reflection on the bodywork part 100 while the electronic unit 900 can be arranged further back relative to the bodywork part 100 so as to protect it from any impact on the bodywork part 100. However, the distance between the electronic unit 900 and the antennas 300a, 300b can be limited, for example less than 500 mm so as to limit the losses or attenuations during the propagation of the electromagnetic wave in the waveguides 700a, 700b.

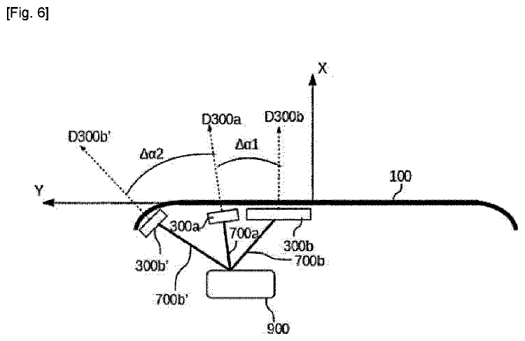

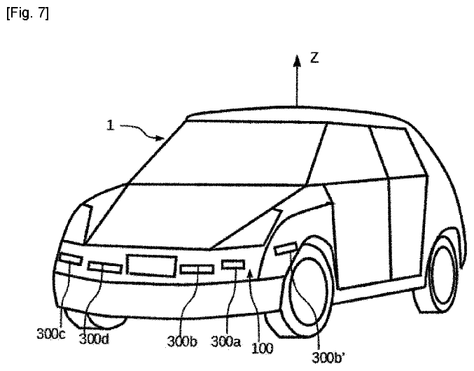

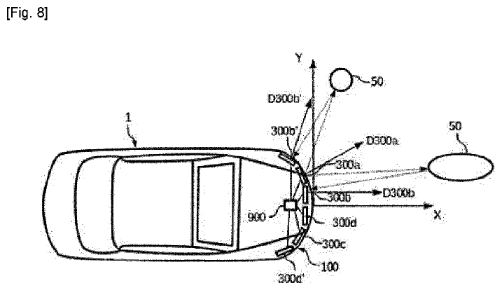

According to a particular embodiment shown in FIGS. 6 to 8, the radar system 200 comprises a transmitting antenna 300a and two receiving antennas 300b and 300b′ arranged on one side of the front bumper 100 of a motor vehicle 1. The antennas 300a, 300b, 300b′ are for example attached to the rear of the skin of the bumper 100. The electronic unit 900 is for example arranged further back relative to the bumper 100 so as to be protected in the event of an impact. The transmitting antenna 300a and the first receiving antenna 300b are for example positioned in a front part of the bumper 100, that is, the part of the bumper oriented substantially perpendicular to the direction X of movement of the vehicle 1 and located between the headlights of the vehicle 1, while the second receiving antenna 300b′ is arranged in a lateral part of the bumper 100, here the left part, the orientation of which is different from the front part, for example laterally beyond the area delimited by the headlights of the vehicle 1 in the example of FIGS. 7 and 8. The lateral part of the bumper, for example, forms an angle of less than 45° with the direction X of advance of the vehicle 1.

The transmitting antenna 300a is arranged between the two receiving antennas 300b and 300b′ in the lateral direction, that is, along the axis Y. Thus, the antennas 300a, 300b and 300b′ are arranged in different areas of the bodywork part 100, the different areas being offset from one another along the width of the vehicle, that is, along the axis Y, and the transmitting antenna 300a is arranged in a central area relative to the areas associated with the receiving antennas 300b and 300b′, which makes it possible to obtain an important detection field for the radar system 200. The central axis D300b of the receiving cone of the first receiving antenna 300b is oriented in azimuth in a direction corresponding substantially to the direction X of advance of the vehicle; the angular deviation in azimuth with the direction X is for example less than 5°, in particular equal to 0° so as to be able to carry out a frontal detection of the obstacles 50 located in front of the vehicle 1 as shown in FIG. 8.

The elevation angle of the central axis D300b is substantially coincident with the horizontal direction; the angular deviation between the central axis D300b and the horizontal direction (plane XY) is in particular less than 5°. The transmitting antenna 300a can have substantially the same orientation as the first receiving antenna 300b or can be angularly offset in azimuth from the side of the second receiving antenna 300b′. The difference in azimuth angle Δα1 between the central axis D300a of the emission cone of the transmitting antenna 300a and the central axis D300b of the receiving cone of the first receiving antenna 300b is for example less than 30°, for example 20° so as to optimize the detection range in the frontal direction X of the vehicle 1. The elevation angle of the central axis D300a of the emission cone C300a of the transmitting antenna 300a is substantially coincident with the horizontal direction; the elevation angle of the central axis D300a is in particular less than 5°, for example equal to 0°. The second receiving antenna 300b′ has an azimuthal orientation different from the first receiving antenna 300b to widen the detection field and allow detection of obstacles 50 located on the side of the vehicle 1. The difference in azimuth angle Δα2 between the central axis D300b′ of the receiving cone of the second receiving antenna 300b′ and the central axis D300a of the transmitting antenna 300a is for example greater than 30°, for example approximately 40°, which makes it possible to widen the detection field of the radar system 200. The elevation angle of the central axis D300b′ of the receiving cone of the second receiving antenna 300b′ is substantially coincident with the horizontal direction, the angle between the central axis D300b′ and the horizontal direction is in particular less than 5°, for example equal to 0°.

Regarding the height position of the antennas 300a, 300b and 300b′ at the bumper 100, the antennas 300a, 300b and 300b′ are preferably positioned above a horizontal plane passing through the highest point of the impact beam and its absorber or below a horizontal plane passing through the lowest point of the impact beam and its absorber.

In the embodiment illustrated in FIG. 6, the first receiving antenna 300b has a length greater than the transmitting antenna 300a and the second receiving antenna 300b′ (the latter two antennas being able to have the same length). An upper antenna length corresponds to a surface of larger dimension making it possible to obtain a larger opening and therefore an improved spatial resolution making it possible to discriminate two distinct elements located at a significant distance, for example 100 m. The first receiving antenna 300b of greater dimension thus makes it possible to increase the spatial resolution in the frontal direction corresponding to the direction X of forward movement of the vehicle 1. The receiving cone of the second receiving antenna 300b′ may comprise an overlap area with the receiving cone of the first receiving antenna 300b. Such an overlap may in particular make it possible to detect a malfunction of one of the receiving antennas 300b, 300b′. In addition, such an overlap makes it possible to track an obstacle moving in the detection field covered by the entire radar system 200 comprising the transmitting antenna 300a and the two receiving antennas 300b and 300b′.

Thus, in operation, the transmitting antenna 300a emits an electromagnetic wave in its emission cone. This electromagnetic wave is reflected by obstacles 50, such as other vehicles or pedestrians or fixed urban elements, and returned to the receiving cone of the first receiving antenna 300b for obstacles located in front of the vehicle 1 and toward the receiving cone of the second receiving antenna 300b′ for the obstacles located on the left side of the vehicle 1 as shown in FIG. 8.

Furthermore, the antennas 300a, 300b, 300b′ can be reconfigured so that a transmitting antenna 300a can be reconfigured to allow reception of the electromagnetic wave and, conversely, a receiving antenna 300b, 300b′ can be reconfigured to emit an electromagnetic wave. Thus, for example, in the event of a malfunction of the transmitting antenna 300a, the first receiving antenna 300b can be reconfigured into a transmitting antenna in order to make it possible to preserve a detection function in association with the second receiving antenna 300b′. However, the detection is then degraded; the range and/or the detection field are for example reduced relative to the initial configuration.

The radar system 200 may also comprise a larger number of receiving antennas, for example to allow detection on the right-hand side of the vehicle 1. The radar system 200 may also comprise several transmitting antennas. In the case of FIGS. 7 and 8, the radar system 200 comprises six antennas, a first transmitting antenna 300a located on the left side of the front bumper 100, a second transmitting antenna 300c located on the right side of the front bumper 100, two receiving antennas 300b and 300b′ located on both sides of the transmitting antenna 300a and two antennas 300d and 300d′ located on both sides of the antenna 300c; the antennas 300c, 300d and 300d′ are for example positioned symmetrically with the antennas 300a, 300b and 300b′ relative to the central plane XZ of the vehicle 1. Such a radar system 200 makes it possible for example to have a detection field at 180°, or even 200°, around the front bumper 100. In addition, the use of an electronic unit 900 common to the different antennas makes it possible to track an object or a person moving in the detection field of the different antennas 300a, 300b, 300b′, 300c, 300d, 300d′. The use of a common electronic unit 900 also makes it possible to limit the latencies in the detection as much as possible.

In addition, the radar system 200 may also comprise a plurality of electronic units 900 and the antennas 300a, 300b can be connected to different electronic units 900. In the embodiments described, an electronic unit 900 comprises a single transmitter 931 and a single receiver 932.

The present disclosure also relates to a bodywork part 100 comprising a radar system 200 as described above. The bodywork part 100 comprises a wall made from plastic on the rear and whereupon one or more antennas are positioned and attached. Preferably, the wall made from plastic material is homogeneous so as not to disrupt the transmission of the electromagnetic wave. The term “homogeneous” is understood here to mean that, for the wall present in front of the same antenna, the thickness is substantially constant, that the same material or the same layers of materials are used and that the wall is solid (without openings as for an air intake grid). For the same reasons, antennas 300a, 300b, 300b′, 300c, 300d, 300d′ will preferably be placed behind a single bodywork part 100 and not straddling different bodywork parts 100. Also preferably, the curvature of the plastic wall facing the antenna is reduced; the radius of curvature is for example greater than 500 mm so as to limit the spaces that can appear between the antenna, which can be flat, and the curved bodywork part. The bodywork part 100 may consist of several components made of plastic material, the antennas being able to be distributed on the various components of the bodywork part 100. For example, for a front bumper, one antenna can be located behind the central panel and another antenna behind the bumper crosshead located next to the wing. The electronic unit 900 can also be attached to the bodywork part 100, but not necessarily against the wall made from plastic material.

The bodywork part 100 may be a front bumper, but may also be a rear bumper, a wing, a side door, a tailgate, a middle/front/rear foot, a side arch or front/rear roof cross-member, or any other bodywork part comprising a wall made from plastic material allowing propagation of the electromagnetic wave emitted by the radar system 200.

The present disclosure also relates to a motor vehicle 1, in particular an automobile, comprising a bodywork part 100 as described above. The vehicle 1 can comprise different bodywork parts 100 comprising different radar systems 1 to allow detection of obstacles around the entire vehicle 1.

The bodywork part 100 may be selected from a front bumper, a rear bumper, a wing, a side door, a tailgate, a middle/front/rear foot, a side arch, a front/rear roof cross-member, or any other bodywork part 100 comprising a wall made from plastic material allowing propagation of the electromagnetic wave emitted by the radar system 200.

The vehicle 1 can also comprise different radar systems 1 whose antennas 300a, 300b are distributed on different bodywork parts 100 of the vehicle 1 to allow detection of obstacles around the entire vehicle 1.

What is claimed is:

1. A radar system for a motor vehicle comprising:
an electronic unit configured to transmit and receive an electromagnetic wave in a predetermined frequency range,
a first directional antenna comprising a first reflective cavity reflecting electromagnetic waves wherein a first metasurface is positioned, said first directional antenna is configured to be connected to the electronic unit via a first waveguide and to transmit the electromagnetic wave, emitted by the electronic unit and propagated via the first waveguide, in a first predetermined direction and/or to propagate the electromagnetic wave received from the first predetermined direction to the electronic unit via the first waveguide; and
a second directional antenna comprising a second reflective cavity reflecting the electromagnetic waves wherein a second metasurface is positioned, said second directional antenna is configured to be connected to the electronic unit via a second waveguide and to transmit an electromagnetic wave, emitted by the electronic unit and propagated via the second waveguide, in a second predetermined direction and/or to propagate the electromagnetic wave received from the second predetermined direction to the electronic unit via the second waveguide.

2. The radar system according to claim 1, wherein the first directional antenna is a transmitting antenna and is configured to emit the electromagnetic wave originating from the electronic unit and propagated via the first waveguide in the first predetermined direction and the second directional antenna is a receiving antenna and is configured to receive the electromagnetic wave emitted by the transmitting antenna and reflected by an obstacle in the second predetermined direction and to propagate the received electromagnetic wave to the electronic unit via the second waveguide.

3. The radar system according to claim 2, wherein the first predetermined direction corresponds to an emission cone around a central emitting axis and the second predetermined direction corresponds to a receiving cone around a central receiving axis.

4. The radar system according to claim 3, wherein an azimuth deviation between the central emitting axis and the central receiving axis is less than 30°.

5. The radar system according to claim 3, wherein a first difference in elevation between the central emitting axis and a horizontal direction and a second difference in elevation between the central receiving axis and the horizontal direction are less than 5°.

6. The radar system according to claim 3, wherein a section of the emission cone and a section of the receiving cone each has an elongated shape, and wherein the first directional antenna and the second directional antenna are arranged so that a pitch angle is less than 30°, wherein the pitch angle is an angular gap between a large axis of the elongated shapes and a horizontal direction for each of the first directional antenna and the second directional antenna, wherein an angular deviation between a pitch angle of the first directional antenna and a pitch angle of the second directional antenna is less than 30°.

7. The radar system according to claim 1, wherein a predetermined frequency range is greater than 60 GHz.

8. The radar system according to claim 1, wherein the first directional antenna and the second directional antenna are configured to be arranged on a bodywork part, wherein the bodywork part comprises a wall made of a plastic material.

9. The radar system according to claim 8, wherein the electronic unit is positioned remotely from the bodywork part.

10. The radar system according to claim 1, wherein the first directional antenna is a transmitting antenna and the second directional antenna is a first receiving antenna, wherein the radar system further comprises:
the transmitting antenna configured to emit the electromagnetic wave emitted by the electronic unit in the first predetermined direction,
the first receiving antenna and a second receiving antenna configured to receive the electromagnetic wave emitted by the transmitting antenna and reflected by an obstacle and to propagate the received reflected electromagnetic wave toward the electronic unit,
wherein the transmitting antenna, the first receiving antenna, and the second receiving antenna are arranged on a bodywork part, wherein the bodywork part comprises a wall made of a plastic material.

11. The radar system according to claim 10, wherein the bodywork part extends along a width of a vehicle and wherein the transmitting antenna, the first receiving antenna, and the second receiving antenna are arranged in different areas of the bodywork part, wherein the different areas are offset from one another along the width of the vehicle, and wherein the transmitting antenna is arranged in a central area relative to areas associated with the first receiving antenna and the second receiving antenna.

12. The radar system according to claim 10, wherein the first receiving antenna defines a first receiving cone around a first central receiving axis forming a first azimuth angle of less than 5° relative to a direction of a forward movement of a vehicle, wherein the second receiving antenna defines a second receiving cone around a second central receiving axis forming a second azimuth angle greater than 20° relative to the direction of the forward movement of the vehicle, and the transmitting antenna defines an emission cone around a central emitting axis forming a third azimuth angle between 0° and 10° with respect to the direction of the forward movement of the vehicle.

13. A bodywork part comprising a radar system, wherein the radar system further comprises:
an electronic unit configured to transmit and receive an electromagnetic wave in a predetermined frequency range,
a first directional antenna comprising a first reflective cavity reflecting electromagnetic waves wherein a first metasurface is positioned, said first directional antenna is configured to be connected to the electronic unit via a first waveguide and to transmit the electromagnetic wave, emitted by the electronic unit and propagated via the first waveguide, in a first predetermined direction and/or to propagate the electromagnetic wave received from the first predetermined direction to the electronic unit via the first waveguide; and
a second directional antenna comprising a second reflective cavity reflecting the electromagnetic waves wherein a second metasurface is positioned, said second directional antenna is configured to be connected to the electronic unit via a second waveguide and to transmit an electromagnetic wave, emitted by the electronic unit and propagated via the second waveguide, in a second predetermined direction and/or to propagate the electromagnetic wave received from the second predetermined direction to the electronic unit via the second waveguide.

14. The bodywork part according to claim 13, wherein the first directional antenna is a transmitting antenna and the second directional antenna is a receiving antenna, wherein the body part further comprises:
at least one wall made of a plastic material,
the transmitting antenna connected to the electronic unit via the first waveguide and configured to emit the electromagnetic wave emitted by the electronic unit in the first predetermined direction,
the receiving antenna connected to the electronic unit via the second waveguide, said receiving antenna being configured to receive the electromagnetic wave emitted by the transmitting antenna and reflected by an obstacle and to propagate the received reflected electromagnetic wave toward the electronic unit, said transmitting antenna and the receiving antenna are arranged behind the wall made of the plastic material.

15. The bodywork part according to claim 14, wherein the transmitting antenna and the receiving antenna are arranged in a uniform area of the bodywork part.

16. The bodywork part according to claim 14, wherein the bodywork part is a front bumper of a vehicle, wherein the receiving antenna is a first receiving antenna, wherein the bodywork part further comprises:
the first receiving antenna arranged in a central area of the bumper, wherein a central axis of a receiving cone of the first receiving antenna is oriented in a direction of a forward movement of the vehicle,
a second receiving antenna arranged in a lateral area of the bumper, wherein a central axis of a receiving cone of the second receiving antenna is oriented at a first azimuth angle greater than 30° relative to the direction of the forward movement of the vehicle, and
the transmitting antenna is arranged in an intermediate area located between the central area and the lateral area, wherein a central axis of an emission cone of the transmitting antenna forms a second azimuth angle between 0 and 30° relative to the direction of the forward movement of the vehicle.

17. The bodywork part according to claim 13, wherein the first directional antenna and the second directional antenna each has an elongated shape and wherein lengths of the first directional antenna and the second directional antenna are different from one antenna to another.

18. A land motor vehicle comprising a bodywork part, wherein the bodywork part further comprises a radar system, wherein the radar system further comprises:
an electronic unit configured to transmit and receive an electromagnetic wave in a predetermined frequency range,
a first directional antenna comprising a first reflective cavity reflecting electromagnetic waves wherein a first metasurface is positioned, said first directional antenna is configured to be connected to the electronic unit via a first waveguide and to transmit the electromagnetic wave, emitted by the electronic unit and propagated via the first waveguide, in a first predetermined direction and/or to propagate the electromagnetic wave received from the first predetermined direction to the electronic unit via the first waveguide; and
a second directional antenna comprising a second reflective cavity reflecting the electromagnetic waves wherein a second metasurface is positioned, said second directional antenna is configured to be connected to the electronic unit via a second waveguide and to transmit an electromagnetic wave, emitted by the electronic unit and propagated via the second waveguide, in a second predetermined direction and/or to propagate the electromagnetic wave received from the second predetermined direction to the electronic unit via the second waveguide.

19. The radar system according to claim 3, wherein a first difference in elevation between the central emitting axis and a horizontal direction and a second difference in elevation between the central receiving axis and the horizontal direction are equal to 0°.

20. The radar system according to claim 1, wherein the predetermined frequency range is between 75 and 80 GHz.

21. The radar system according to claim 6, wherein the section of the emission cone and the section of the receiving cone each has an oblong shape.

22. The radar system according to claim 6, wherein the first directional antenna and the second directional antenna are arranged so that the pitch angle is less than 5°.

23. The radar system according to claim 6, wherein the angular deviation between the pitch angle of the first directional antenna and the pitch angle of the second directional antenna is less than 5°,

24. The radar system according to claim 12, wherein the first azimuth angle is 0° relative to the direction of the forward movement of the vehicle.

25. The radar system according to claim 12, wherein the second azimuth angle is 40° relative to the direction of the forward movement of the vehicle.
